(19) United States
(12) Patent Application Publication
(10) Pub. No.: US 2013/0206555 A1
(43) Pub. Date: Aug. 15, 2013

(54) ON-LOAD TAP CHANGER

(71) Applicants: Juergen Donhauser, Schwandorf (DE); Roland Meisel, Pfreimd (DE); Christian Pircher, Lappersdorf (DE)

(72) Inventors: Juergen Donhauser, Schwandorf (DE); Roland Meisel, Pfreimd (DE); Christian Pircher, Lappersdorf (DE)

(21) Appl. No.: 13/809,917

(22) PCT Filed: Jul. 7, 2011
(86) PCT No.: PCT/EP11/03393

§ 371 Date: Mar. 27, 2013

(30) Foreign Application Priority Data
Aug. 18, 2010 (DE) 20 2010 011 521.3

(51) Int. Cl. H01H 9/00

(52) U.S. Cl. CPC H01H 9/0005
USPC 200/11 TC

(57) ABSTRACT

The invention relates to an on-load tap changer for switching among different winding taps of a step transformer without interruption. The general inventive concept lies in eliminating the previously static design of the on-load tap changer, comprising a load transfer switch and a selector adjoining directly under the load transfer switch, and to bring about a spatial separation of the load transfer switch and selector assemblies.

The invention relates to an on-load tap changer for uninterrupted switching over between different winding taps of a tapped transformer, according to the preamble of the first patent claim.

On-load tap changers serve, as is known, for uninterrupted switching over between different winding taps of a tapped transformer and thus for voltage regulation. They usually consist of a selector for power-free selection of that winding tap of the tapped transformer that is to be switched over to as well as a load changeover switch for the actual uninterrupted switching over from the previously connected winding tap to the new, preselected winding tap. The load changeover switch has for that purpose the components required for such an uninterrupted rapid is switching over, particularly an energy store, a drive shaft, switching contacts—these can be mechanical switching contacts, vacuum switching cells or also thyristors—as well as means for actuation of the switching contacts in a predetermined switching sequence for each changeover process.

Known load changeover switches usually additionally have an individual oil vessel, usually in the form of a closed insulating-material cylinder in which all mentioned components are located separately from the surrounding oil of the transformer. Arranged to be located directly below the load changeover switch, but in the transformer oil, is the selector, which is connected with the central drive shaft of the load changeover switch by way of a transmission stage. The central drive shaft of the load changeover switch is driven by way of a motor drive, which is outside the transformer vessel and that slowly draws up the energy store by means of a linkage—that is similarly led along the transformer vessel at the outside—and in that case also simultaneously actuates the selector. The central drive shaft is thus responsible not only for actuation of the switching contacts of the load changeover switch during the actual rapid switching over, but also for actuation of the selector, which is directly below the load changeover switch, during the slow drawing-up process of the energy store.

On-load tap changers of that kind are products established for decades on the market and are known from, for example, the company publication of the applicant “Oiltap® M Laststufenschalter für Regeltransformatoren.” Shown on page 1 of the company publication is an on-load tap changer of the kind according to category, which has in the upper region, within the insulating cylinder, a load changeover switch and directly adjacent thereto the selector, which is connected by way of a transmission stage with the drive shaft of the load changeover switch. Not shown in this illustration is the energy store and the motor drive in operative connection therewith by means of a linkage.

This described construction, which has been current for many years in the prior art, is, however, space-consuming for transformer constructors, since it takes up a relatively large amount of constructional space within the transformer vessel and thus limits the degree of freedom of the transformer constructor in the construction of the actual transformer in the transformer vessel, which is confined in terms of space. This is not least because a relatively large constructional space has to be left free within the transformer vessel for location of the placement of the on-load tap changer and this space still cannot be flexibly designed for the purpose, but is quasi predetermined by the construction of the on-load tap changer, consisting of load changeover switch and selector directly thereunder, known from the prior art.

The company publication “Stufenschalter Typ G” of the applicant in that case reveals a typical arrangement of an on-load tap changer according to category in the configuration, i.e. in the combination, of tap changer and regulating transformer. As apparent from the cover sheet, an on-load tap changer of that kind, is thus load changeover switch and associated selector, is at a specific dielectric spacing from the individual windings of the transformer within the transformer vessel and from the walls of the transformer housing. In that case, apart from the on-load tap changer, consisting of load changeover switch and selector directly adjoining underneath, the installation of the individual dielectrically insulated copper lines from the corresponding winding taps of the regulating winding of the transformer to the respective selector contacts requires a substantial amount of space. The line guidance, which is fastened to the transformer active part by the shunt equipment is, however, not only time-consuming in its installation, but also due to the requisite electrically conductive characteristics thereof made of copper and thus very expensive.

The object of the present invention is therefore to indicate an on-load tap changer of the kind stated in the introduction that allows for the transformer constructor a more flexible design possibility of the constructor's transformer and in addition makes the space-consuming and expensive line guidance inclusive of shunt equipment redundant.

This object is fulfilled by an on-load tap changer with the features of the first claim. The subclaims in that case relate to particularly preferred further developments of the invention.

The general inventive concept consists in breaking up the previously static construction of the on-load tap changer, consisting of load changeover switch and selector directly adjoining thereunder, and creating a physical separation of the two subassemblies of load changeover switch and selector in that the selector is then as close as possible to the winding taps of the regulating winding of the tapped transformer. The connecting lines between the corresponding connecting contacts of the selector and the individual winding taps of the regulating winding of the tapped transformer can thus be shortened to a minimum; in particular this makes the complicated and costly line guidance together with the shunt equipment redundant.

According to a preferred form of embodiment of the invention the at least one selector is directly at the winding taps of the regulating winding of the transformer, thus in the interstice thereof. Due to the fact that the previously provided constructional space for the selector within the transformer vessel can thus be eliminated and instead thereof this can be placed in the already present constructional space of the interstice, i.e. directly at the winding taps of the regulating windings of the transformer winding, the physical separation of the subassemblies of load changeover switch and selector creates space in the transformer vessel.

According to a further preferred form of embodiment of the invention the linkage that connects the motor drive with the energy store of the load changeover switch is led directly in the interior of the transformer vessel onward from the load changeover switch to the selector and thus used in a particularly simple manner to also drive the selector.

According to yet a further form of embodiment of the is invention the linkage is in that case no longer led, as in the past, to the outer side of the transformer vessel along the upper side thereof and only there connected with the energy store of the on-load tap changer, but led directly through a lateral wall of the transformer vessel.

According to yet a further preferred form of embodiment of the invention the load changeover switch and the at least one selector are each actuated by a specific drive, for example in the form of a motorized direct drive. This makes the previously functionally necessary central motor drive inclusive of complicated linkage to the load changeover switch superfluous and can be directly above or below the load changeover switch or the at least one selector. If the motorized direct drive is a linear motor or torque motor, then in the case of the load changeover switch it is also possible to dispense with the otherwise functionally obligatory spring energy store.

The invention is explained in more detail in the following by way of a figure, in which:

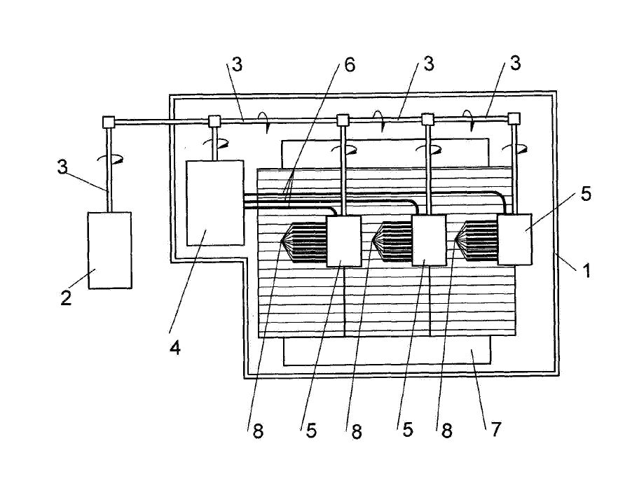

FIG. 1 shows a schematic illustration of an on-load tap changer according to the invention with physically separated load changeover switch and selector.

Illustrated in FIG. 1 is a transformer vessel, in the interior of which is disposed a yoke 7 at which at least one winding, comprising a main winding and a regulating winding with winding taps 8, is arranged. In addition, a motor drive 2, which by way of a linkage 3 produces an operative connection with a load changeover switch 4 in the interior of the transformer vessel 1 and with at least one selector 5, is disposed at the outer lateral wall of the transformer vessel 1. The load changeover switch 4, which is illustrated in this FIG. 1 only in very abstract form, is a load changeover switch 4 that has become known from, for example, the already mentioned company publication “Oiltap® M Laststufenschalter für Regeltransformatoren” of the applicant. This load changeover switch 4 is electrically connected with the corresponding selector 5 by way of lines 6. According to the invention the at least one selector 5 is positioned directly at the winding taps 8 of the regulating winding of the transformer, which shortens the connecting lines between the corresponding connecting contacts of the selector and the individual winding taps 8 of the regulating winding of the tapped transformer to a minimum. In particular, with the solution according to the invention the connecting lines, which are complicated in installation and in addition expensive, together with the shunt equipment are redundant. The linkage 3 driven centrally by way of a single motor drive 2 is so constructed that it is in operative connection not only with the load changeover switch 4, but also with the at least one selector 5.

1. An on-load tap changer for uninterrupted switching over between different winding taps of a regulating winding of a tapped transformer, the tap changer comprising:
at least one selector for power-free selection of the respective winding tap of a tapped transformer that is to be switched over to and a load changeover switch for the actual switching over from the connected to the new, preselected winding tap, the at least one selector and the load changeover switch being spatially separate from one another.

2. The on-load tap changer according to claim 1, wherein the at least one selector is in the transformer vessel of the tapped transformer.

3. The on-load tap changer according to claim 1, wherein the at least one selector is in the immediate spatial vicinity of the respective winding taps of the regulating winding of the tapped transformer.

4. The on-load tap changer according to claim 1, wherein the at least one selector and the load changeover switch are drivable by way of a common linkage.

5. The on-load tap changer according to claim 1, wherein the linkage is led through the lateral wall into the transformer vessel and extends at least partly therein.

6. The on-load tap changer according to claim 1, wherein the at least one selector and the load changeover switch are actuatable by a linear motor or a torque motor.

7. The on-load tap changer according to claim 1, wherein several selectors are of identical construction.
